(19) United States
(12) Patent Application Publication
(10) Pub. No.: US 2012/0030190 A1
(43) Pub. Date: Feb. 2, 2012

(54) METHOD OF RECORDING AND SEARCHING FOR A WEB PAGE AND METHOD OF RECORDING A BROWSED WEB PAGE

(76) Inventors: Hong-Lin LEE, Taipei City (TW); Shan-Ta Chen, Taipei City (TW)

(21) Appl. No.: 13/084,176

(22) Filed: Apr. 11, 2011

(30) Foreign Application Priority Data
Aug. 2, 2010 (TW) 099125623

(51) Int. Cl. G06F 17/30

(52) U.S. Cl. 707/711; 707/706; 707/E17.108; 707/E17.002

(57) ABSTRACT

A method of recording and searching for a Web Page allows a user to find Web Pages he or she has browsed. A plurality of users can input key words to find Web Pages they have browsed and recorded via the history of browsed Web Pages. What is different from a prior art search engine server is that the search engine server of the present invention only provides the Web Pages which the plurality of users have browsed and recorded. In addition, in order to reduce the burden of the search engine, it is recommended that the Web Page contents be uploaded from the user's browser to the search engine server.

### BACKGROUND OF THE INVENTION

1. Field of the Invention

The present invention relates to a data collecting method for a search engine and a method of recording Web Pages a user has browsed.

2. Description of the Related Art

FIG. 1 is a schematic drawing of the operation of a known search engine 86 according to a prior art. The search engine 86 automatically retrieves Web Pages 84 and stores them in a Web Page database 85. In addition, a user can also actively register the address of a Web Page 83 on the search engine 86 (search Websites such as Google™ and Yahoo™) via a Web browsing device 82 (e.g., a personal computer). Usually the user has to fill in some information to register a Web Page on the search engine 86. For example, U.S. Pat. No. 6,631,496, entitled “System for Personalizing, Organizing and Managing Web Information,” discloses this function.

The quality of a search engine depends on the degree of accuracy felt by the user. With the expansion of a commercial scale, a search engine today may have to index the contents of ten million or more Web Pages. The load is beyond the limit of manpower. Thus, many figures and statistical data assist the search engine in ranking and the determination of a query. Website owners tend to hope their websites will be found easily and displayed at the top of a page when a user conducts a search with the search engine, so that the user will be more likely to click on their websites.

The search engine brings convenience. However, because of the high number of Web Pages of the internet, the user often spends much time looking for information. When the user has found information he or she wants and may need the information again, the user usually adds those Web Pages into bookmarks.

Recording Web Page bookmarks, however, also places a heavy burden on the user. The number of bookmarks keeps growing, so the user has to manage the bookmarks and divide them into categories. The number of the categories then keeps increasing, and the Web addresses in each category also keep increasing. In the end, the user has to deal with the problem of considerable quantities of Web Page bookmarks.

U.S. Pat. No. 6,631,496, entitled “System for personalizing, organizing and managing web information”, as mentioned above, allows the user to fill in data to register with a search machine. Also, the search engine automatically hierarchically classifies the bookmarks according to the data filled in by the user and Web Pages contents to solve the problem of classifying the bookmarks. The bookmarks can be shared with different users. U.S. Pat. No. 6,631,496 creates bookmarks with categories and classifies the bookmarks by a unified method. The method of automatic classification, however, does not match all users' habits. The search engine provides a key word search function as well. In addition, the search engine of U.S. Pat. No. 6,631,496 automatically retrieves Web Page contents. This places a heavy burden on the search engine. Also, the search engine of U.S. Pat. No. 6,631,496 stores Web Page contents linked by Web Page contents, like a prior art search engine.

In addition, U.S. Pat. No. 6,366,923, entitled “Gathering selected information from the world wide web,” provides a system for conducting a search on the Internet. Also, the user can record the contents of Web Pages and save them in a file in his/her computer. By using this method, however, the user has to record the contents of the Web Pages in his/her computer and can only search his/her record; in addition, the user cannot share the record.

A browser provides “my history” for the user to record browsed Web Pages. In addition, Google™ also provides the history. “My history”, however, is not for sharing with others because of privacy issues.

### SUMMARY OF THE INVENTION

A search engine of the present invention allows a user to find Web Pages that he or she has browsed. Some of the browsed Web Pages are automatically recorded; some of them are manually recorded. The present invention is different from a prior art internet bookmark. When using a prior art internet bookmark, the user has to input key words to look for the browsed Web Pages. In addition, a prior art internet bookmark basically allows the user to record only the Web address of a domain name, not including the contents. The prevent invention, however, allows the user to record Web Page contents that he or she is interested in.

A plurality of users can input key words to find Web Pages that they have browsed and recorded via the history of browsed Web Pages. What is different from a prior art search engine server is that the search engine server of the present invention only provides the Web Pages which the plurality of users have browsed and recorded. In addition, in order to reduce the burden of the search engine, it is recommended that the Web Page contents be uploaded from the user's browser to the search engine server.

The feature of the search engine server of the present invention is that the contents of the Web Page database in the search engine server are determined by the user (Web browsing device) and are not automatically selected and stored by the search engine server. The user does not have to register a Web Page on the search engine server through a complicated process.

An embedded search interface has to be embedded in the user's browsing program. According to the embodiments, the embedded search interface comprises a key word input interface, a search confirmation button, a manual transmission button, and a setting button. The setting button comprises buttons such as the following: automatically add, search individual, set up username, set up blacklist and whitelist, add label, today's favorites, my history, and login. When the setting of the button automatically add is ON, all Web Pages browsed by the user are automatically uploaded to the search engine server. When it is OFF, the user has to click the manual transmission button to upload a browsed Web Page to the search engine server.

The user can add specific domain names into a blacklist to prevent private Web Pages from being uploaded. In addition, after the user clicks my history, he or she can browse recorded Web Pages and click a delete button to delete the history.

### BRIEF DESCRIPTION OF THE DRAWINGS

FIG. 1 is a schematic drawing of the operation of a known search engine according to a prior art.

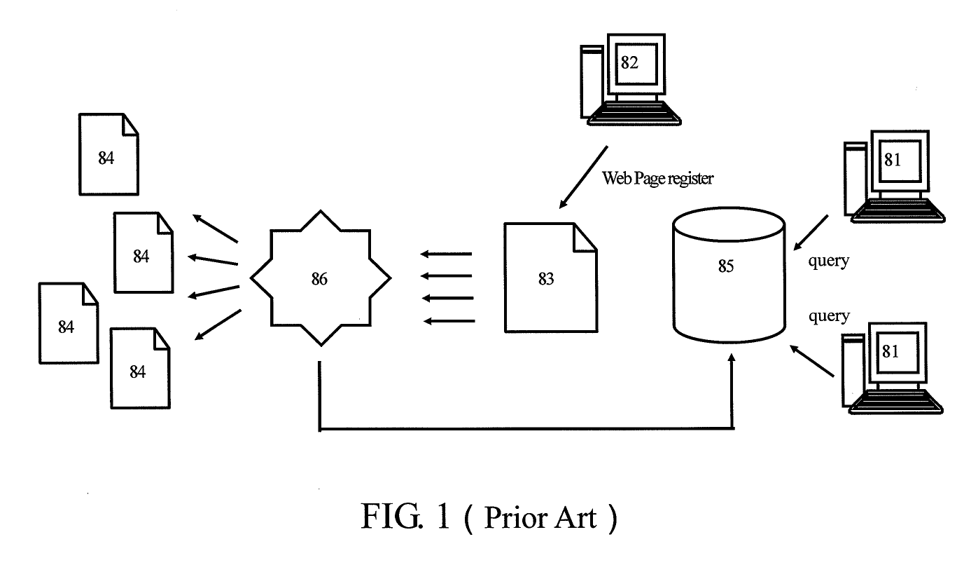

FIG. 2 is a schematic drawing of the operation of a search engine server of the present invention.

FIG. 3 is a flowchart of the present invention.

FIG. 4 is an embodiment of an embedded search interface of the present invention.

FIG. 5 is the embodiment of the embedded search interface of the present invention showing an unfolded menu.

FIG. 6 is the embodiment of the embedded search interface of the present invention showing a function of “set up username”.

FIG. 7 is the embodiment of the embedded search interface of the present invention showing a function of “set up blacklist and whitelist”.

FIG. 8 is the embodiment of the embedded search interface of the present invention showing a function of “set up add label”.

FIG. 9 is a schematic drawing of a Web Page database of the present invention.

FIG. 10 is the embodiment of the embedded search interface of the present invention showing a function of “today's favorites”.

FIG. 11 is the embodiment of the embedded search interface of the present invention showing a function of “my history”.

FIG. 12 is the embodiment of the embedded search interface of the present invention showing a function of “search”.

FIG. 13 is the embodiment of the embedded search interface of the present invention showing a “search” results Web Page.

FIG. 14 is the embodiment of the embedded search interface of the present invention showing a “search” results Web Page, but the results are limited within a personal record.

FIG. 15 is a flowchart of a second embodiment of the present invention.

### DETAILED DESCRIPTION OF THE PREFERRED EMBODIMENT

The advantages and innovative features of the invention will become more apparent from the following detailed description when taken in conjunction with the accompanying drawings.

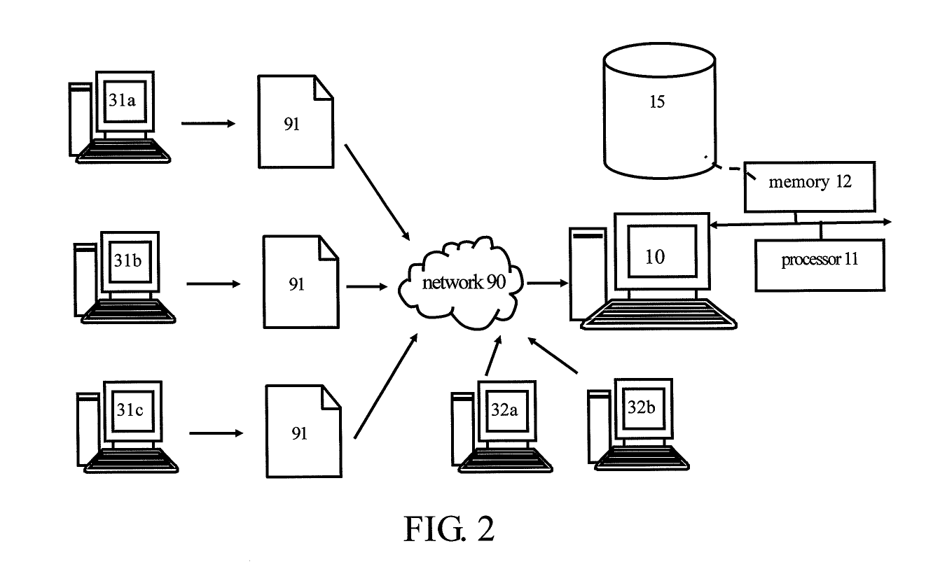

Please refer to FIG. 2, a schematic drawing of the operation of a search engine server 10 of the present invention, for the following paragraphs. The search engine server 10 comprises a processor 11 and a memory 12. The memory 12 stores a search engine program. The processor 11 executes the search engine program so as to manage a Web Page database 15 and perform the function of a search engine. The search engine server 10 is usually composed of devices such as many computers and numbers of hard disks. FIG. 2 is just a schematic drawing.

Web browsing devices 31a, 31b, 31c upload Web Pages 91 desired to be recorded to the search engine server 10 via a network 90. Web browsing devices 32a, 32b can perform a search also via the network 90. The contents of the Web Page database 15 are determined by a user (Web browsing device 31a, 31b, 31c) and are not automatically selected and stored by the search engine server 10. It should be noted that in FIG. 2, the Web browsing devices 31a, 31b, 31c can also perform a search; the Web browsing devices 32a, 32b can also upload Web Pages to the search engine server 10. FIG. 2 is just for the illustration of an example.

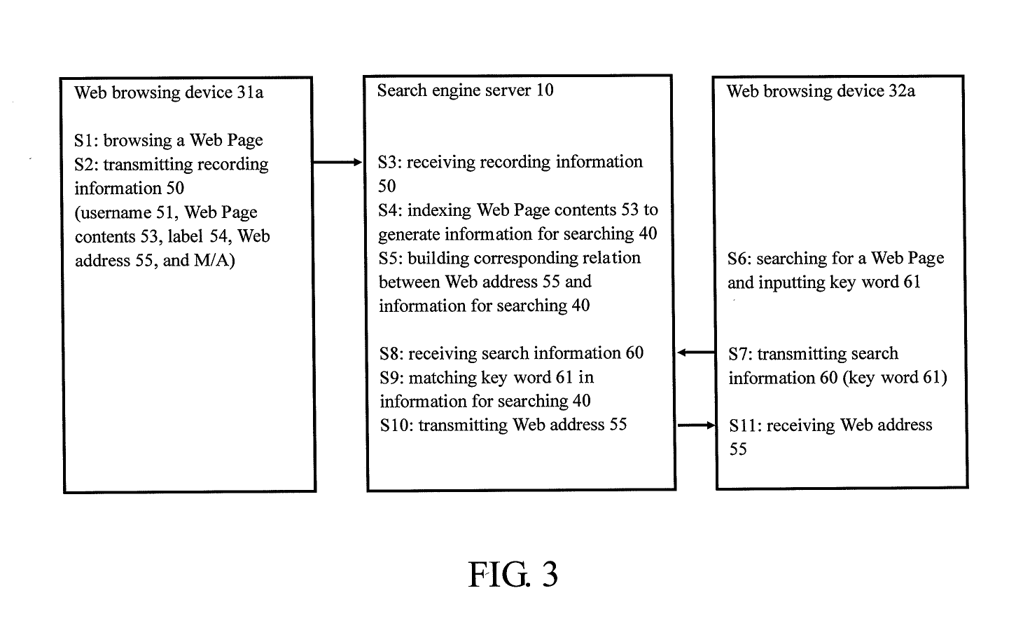

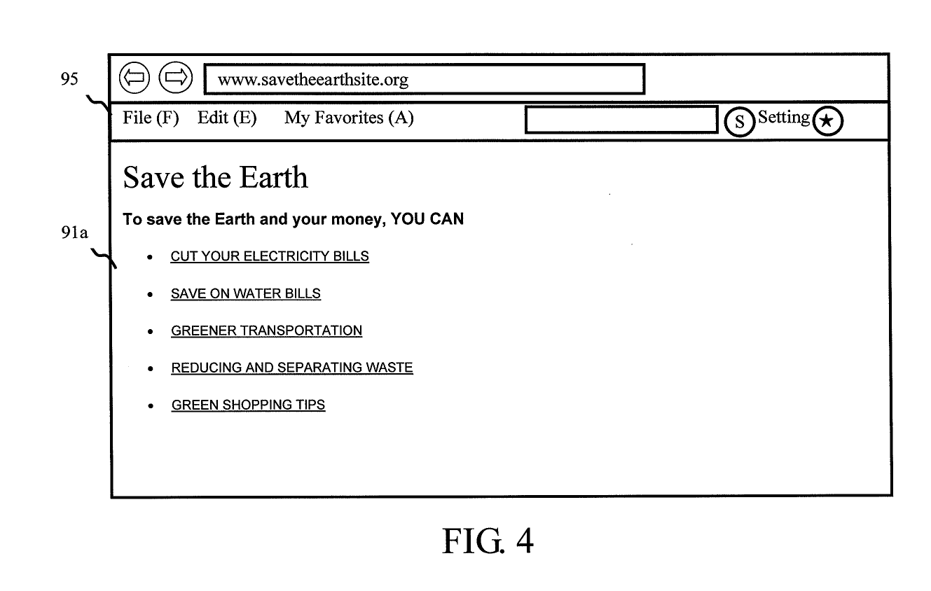

Please refer to FIG. 3, a flowchart of the present invention. Please also refer to FIGS. 4˜14. The following paragraphs use the Web browsing device 31a and the Web browsing device 32a for illustration.

### Step S1:

A first user (not shown) browses a Web Page 91a via a browsing program 95 of the Web browsing device 31a, as shown in FIG. 4.

### Step S2:

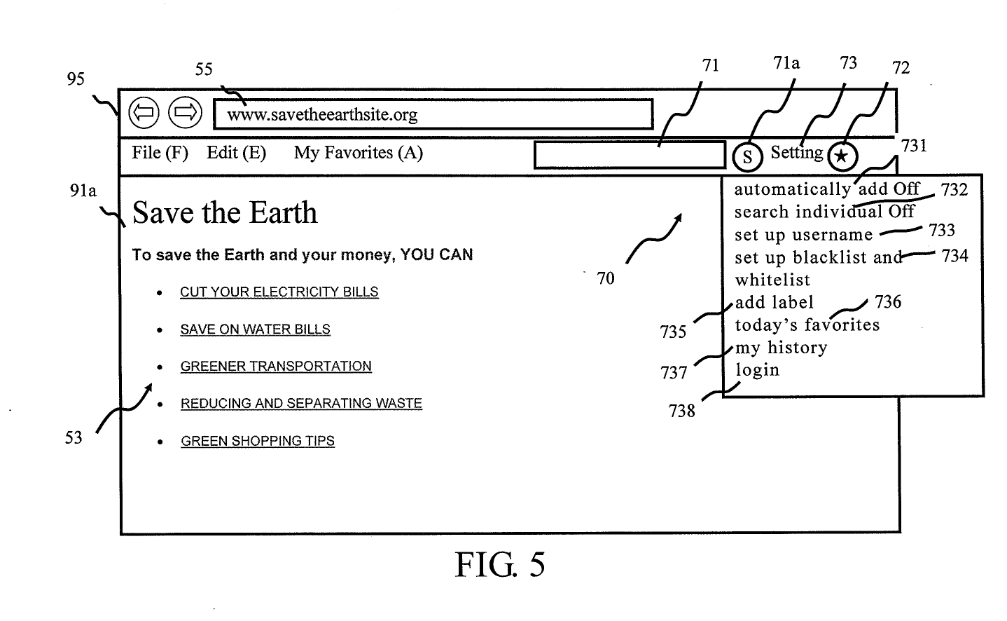

Please refer to FIG. 5. If the first user likes the Web Page 91a, he or she clicks a manual transmission button 72 to transmit recording information 50 corresponding to the Web Page 91a to the search engine server 10.

The manual transmission button 72 is one of the buttons of an embedded search interface 70. In the present invention, the embedded search interface 70 is embedded in the browsing program 95, as shown in FIG. 5. In this embodiment, the embedded search interface 70 primarily comprises a key word input interface 71, a search confirmation button 71a, a manual transmission button 72, and a setting button 73. The setting button 73 comprises buttons such as automatically add 731, search individual 732, set up username 733, set up blacklist and whitelist 734, add label 735, today's favorites 736, my history 737, and login 738.

In a state shown in FIG. 5, the setting of the automatically add 731 is OFF, which means that when the first user browses the Web Page 91a, the recording information 50 corresponding to the Web Page 91a is not automatically transmitted to the search engine server 10. Conversely, when the setting of the automatically add 731 is ON (not shown in FIG. 5), then when the first user browses the Web Page 91a, the recording information 50 corresponding to the Web Page 91a is automatically transmitted to the search engine server 10.

The recording information 50 comprises at least a Web address 55 and preferably Web Page contents 53 as well. The Web browsing device 31a transmits the Web Page contents 53 (codes for describing a Web Page, such as text contents, HTML, XHTMAL, JavaScript, and CSS) to the search engine server 10. This reduces the burden of the search engine server 10 and is different from the prior art operation of a search engine. The recording information 50 can also comprise the setting that a Web Page transmitted to the search engine server 10 is manually transmitted or automatically transmitted (according to the setting of the automatically add 731). For example, “M” stands for “manually transmitted”. “A” stands for “automatically transmitted”. Thus the search engine server 10 can determine the importance of Web Pages according to the information.

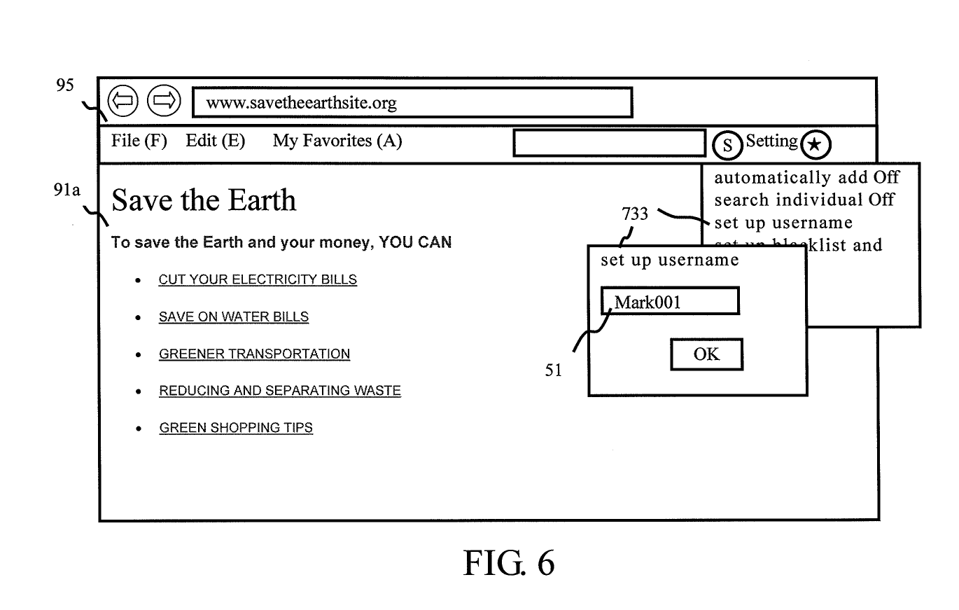

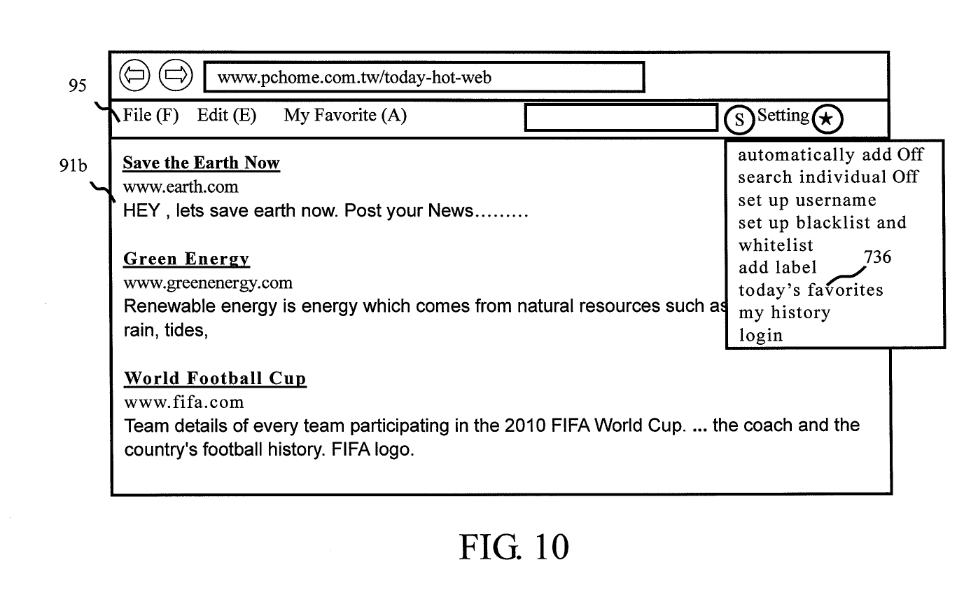

Please refer to FIG. 6. A user can click the set up username 733 to set up a username (such as an ID and a member code). If a username 51 is set up, the recording information 50 can comprise the username 51 so that the search engine server 10 can record who uploads the Web Pages (please refer to the illustration of FIG. 10 in step 5 for the advantage of recording a username). After the username is set up, the user can click the login 738.

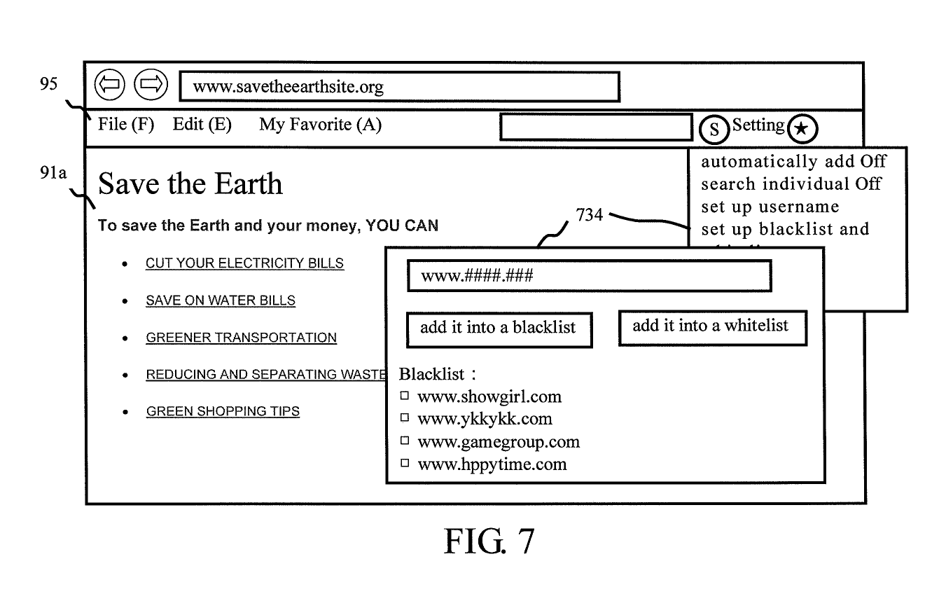

Sometimes the user does not want to upload a Web Page with some specific domain name because of privacy issues. Whether the setting of the automatically add 731 is ON or OFF, the user can click the set up blacklist and whitelist 734, as shown in FIG. 7. The user can then input a specific domain name and set a blacklist to prevent the Web Page contents from being uploaded. Of course, the user can also change a blacklist into a whitelist.

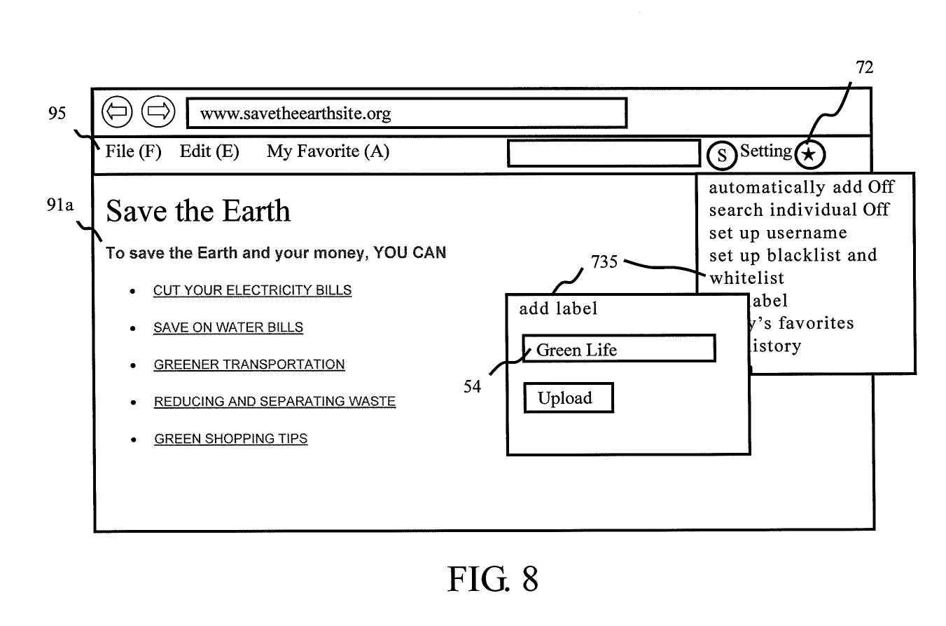

The user can further set a label for the Web Page 91a, which is desired to be recorded. Please refer to FIG. 8. The user can click add label 735 and then click the manual transmission button 72. For example, the user inputs “Green Life” into a label 54. The recording information 50 can further comprise the label 54 so that the search engine server 10 can record the label 54 corresponding to the Web Page 91a. The user can simply input “Green Life” to look for the recorded Web Page 91a later.

### Step S3:

The search engine server 10 receives the recording information 50. As described in step 2, the recording information 50 may comprise at least the Web address 55 and may further comprise the Web Page contents 53, the label 54, the username 51, and the record that a Web Page is manually transmitted or automatically transmitted (such as “M” or “A”).

### Step S4:

Indexing the Web Page contents 53 to generate information for searching 40. The search engine server 10 can obtain corresponding Web Page contents 53 according to the Web address 55. The Web Page contents 53 can also be obtained from the recording information 50 transmitted by the Web browsing device 31a. Indexing the Web Page contents 53 is a well known technique. It primarily deletes unnecessary contents of the Web Page contents 53 and repeated text. The unnecessary contents are primarily codes.

The search engine server 10 can also have the setting of a blacklist. If an uploaded Web address is related to privacy, the search engine server 10 will not record the Web address uploaded by the user and Web Page contents.

### Step S5:

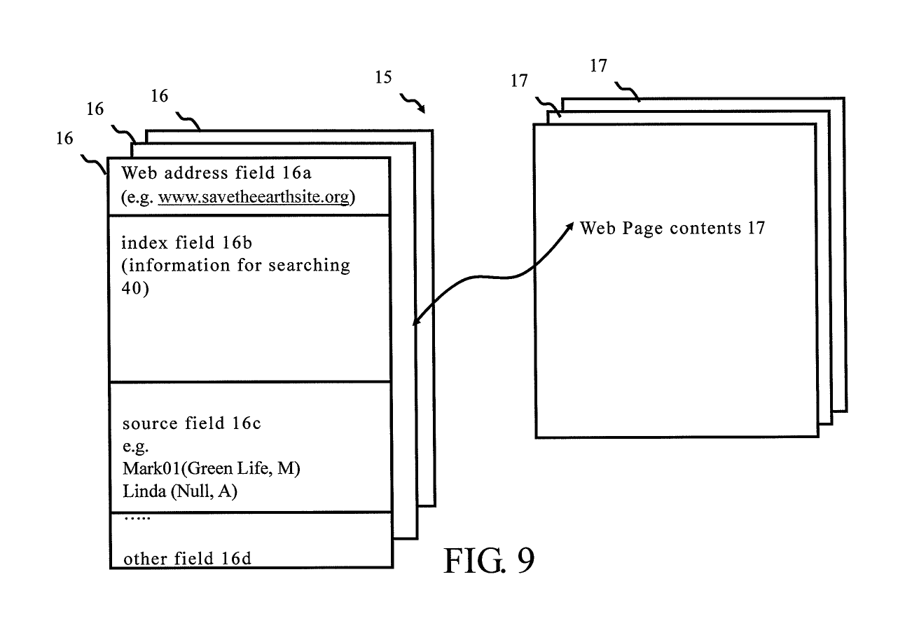

Building a corresponding relation between the Web address 55 and the information for searching 40. Please refer to FIG. 9. The Web Page database 15 of the search engine server 10 comprises a plurality of index contents 16 and corresponding Web Page contents 17. The Web Page contents 17 are generally saved as a database. It can be a backup of Web Pages or a backup when there is a problem in the index contents 16.

Index contents 16 can be seen as pages of data. Each of the index contents 16 corresponds to a Web address 55. The index contents 16 mainly comprise a Web address field 16a, an index field 16b, a source field 16c, and an other field 16d. All columns of the index contents 16 have corresponding relations.

The Web address field 16a records the Web address 55 of the recording information 50, such as www.savetheearthsite.org.

The index field 16b records the information for searching 40 generated in step S4.

The source field 16c records the username 51, the label 54, and the setting that an uploaded Web Page is manually transmitted or automatically transmitted (for example, represented by “M” or “A”, please refer to step S2). If ten users who have set up usernames upload the same Web address, the usernames of the ten users will be recorded in the source field 16c. In addition, if the user has set a label for the Web address, it is recommended that the label together with the username be saved in the source field 16c. For example, Mark01 (Green Life, M) means that user Mark01 uploaded the Web Page manually and added the label Green Life. Linda (Earth, A) means that the Web Page was automatically uploaded when the user Linda browsed the Web Page, and that there is no label (Null) for the Web Page.

The other field 16d records, for example, the time when the index contents 16 are generated, how many users upload Web Pages, how many times the Web Page has been browsed, the time when the Web Page is browsed, and its importance.

Please refer to FIG. 10. After the user clicks, for example, the today's favorites 736, Web Page 91b can display the Web Pages of today's favorites because how many times a Web Page has been browsed and the time when the Web Page is browsed can be recorded in the other field 16d of the index contents 16.

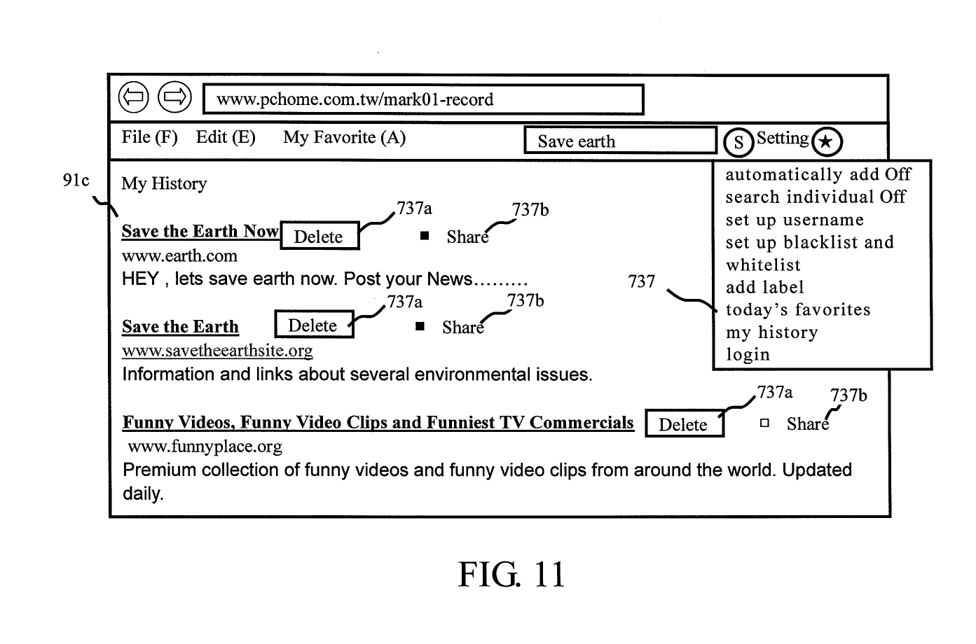

Please refer to FIG. 11. The username 51 can be recorded in the source field 16c of the index contents 16. Thus, after the user clicks my history 737, Web addresses recorded by the user “Mark01” can be displayed like a Web Page 91c. The user can browse recorded Web Pages and click a delete button 737a to delete the history. After the user deletes the history, he or she has to transmit the deletion.

In addition, the user can also determine whether or not to share the recorded Web Pages with others. It is predetermined whether recorded Web Pages will be shared with others (or will not be shared with others) after the recording information 50 is transmitted to the search engine server 10 (step S2). For example, after the user clicks my history 737, he or she can change the state of sharing into “shared” or “not shared” via a share button 737b. As shown in FIG. 11, for example, the share button 737b being a black square means “shared”. The share button 737b being a hollow square means “not shared”.

Of course, after the delete button 737a or the share button 737b is clicked, the Web browsing device 31a transmits a message of change to the search engine server 10 to change the Web Page database 15.

### Step S6:

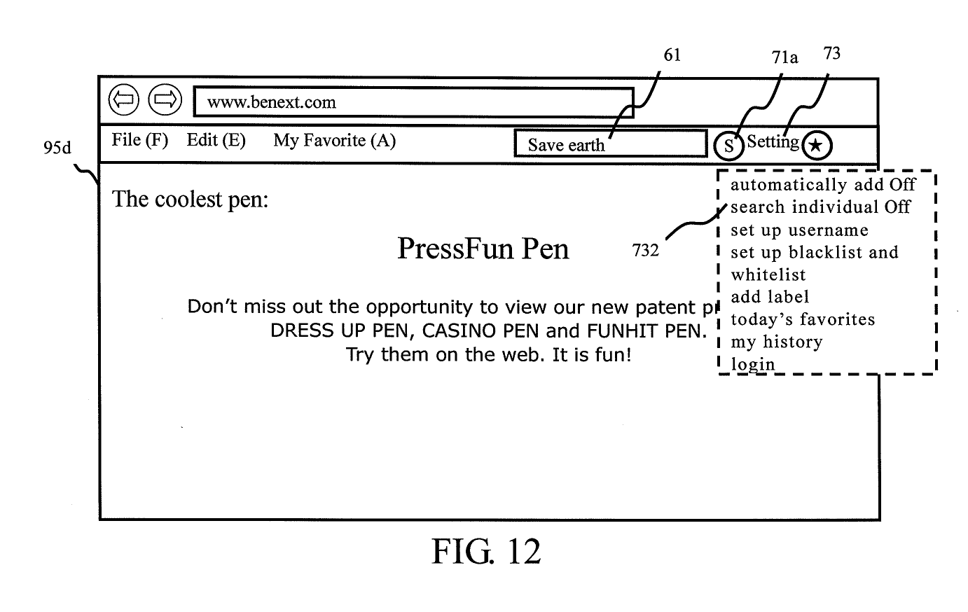

Please refer to FIG. 12. A second user (not shown) searches for a Web Page via a browsing program 95d of the Web browsing device 32a. He or she inputs at least one key word 61 (e.g., “save earth”) and presses the search confirmation button 71a.

If the setting of the search individual 732 of the setting button 73 is “Off” when the second user searches for Web Pages, it means that the second user wants to search all the Web addresses comprising the key word 61 in the information for searching 40.

### Step S7:

The Web browsing device 32a transmits the search information 60 to the search engine server 10. The search information 60 comprises the key word 61 and can further comprise other information such as a username of the second user (especially when the setting of the search individual 732 is “On” in step S6).

### Step S8:

The search engine server 10 receives the search information 60.

### Step S9:

The search engine server 10 matches the key word 61 in the information for searching 40. This technique about a search engine is well known to any person familiar in the field, and so requires no further description.

### Step S10:

The search engine server 10 transmits Web addresses 55 which meet the search condition and extracted information (usually a part of the Web Page contents which comprise key words) to the Web browsing device 32a.

### Step S11:

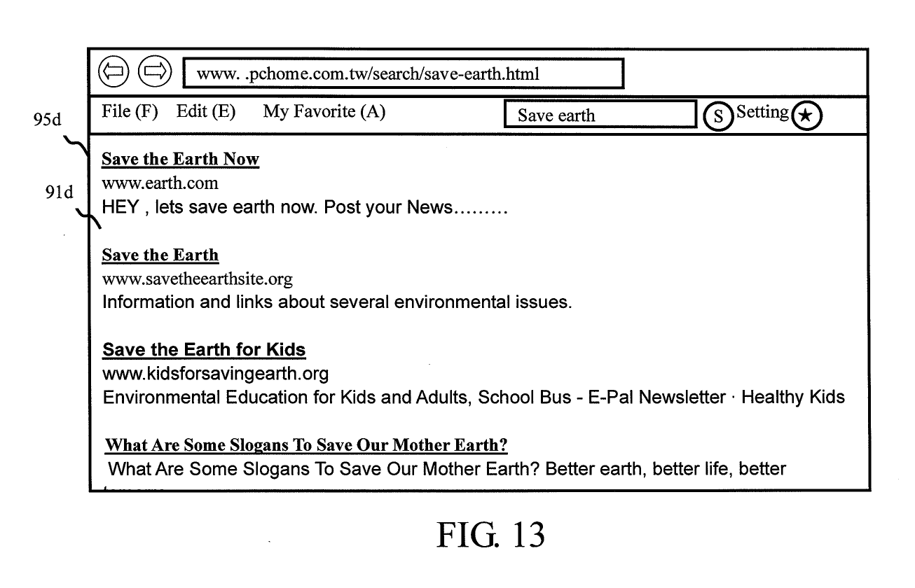

The Web browsing device 32a receives the Web addresses 55 and the extracted information and displays them on a Web Page 91d, as shown in FIG. 13.

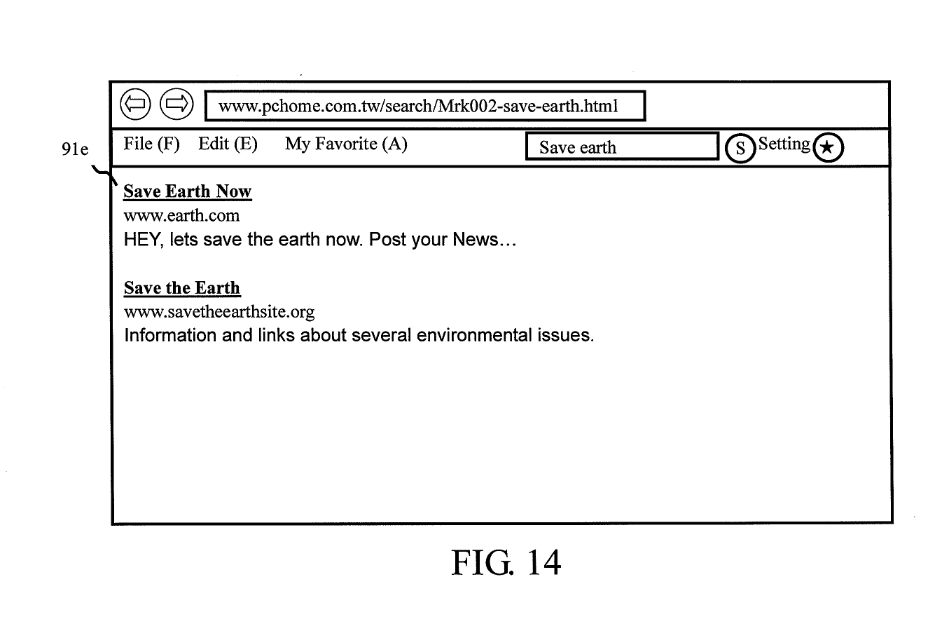

It should be noted that if the setting of the search individual 732 is “On” in step S6, the search information 60 comprises not only the key word 61 but also the username of the second user. Thus, in step S9, the search engine server 10 not only matches the key word 61 in the information for searching 40 but also checks if the record is the second user's. For example, as shown in FIG. 14, a Web Page 91e only displays the Web addresses which meet the key word 61 and which are recorded by the second user.

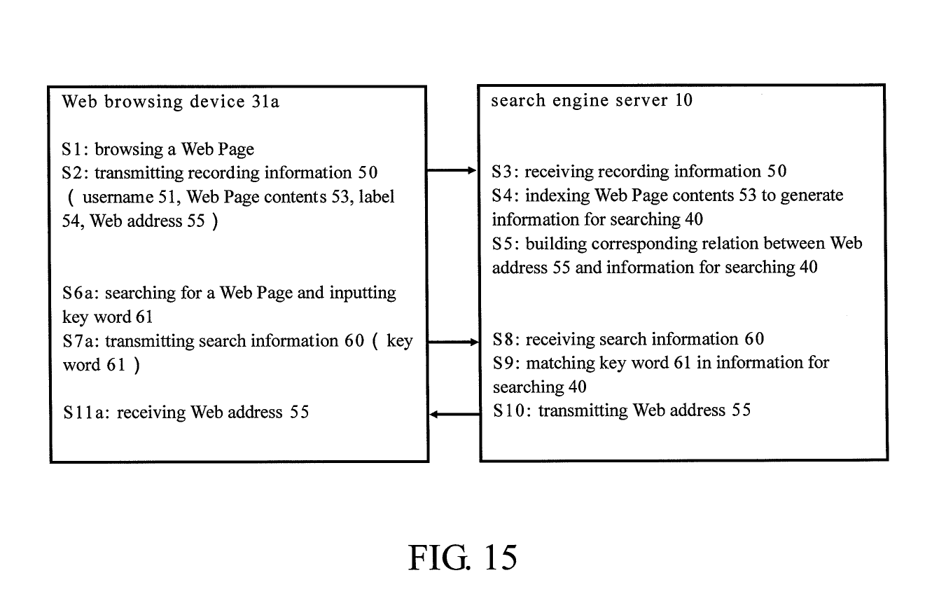

In addition, it should be noted that the present invention is for multiple users. Each user can record the Web addresses and can also conduct the Web addresses recorded by him/her or other users. In order to facilitate the illustration of the primary issue of the present invention, the flowchart of FIG. 3 uses the first and second users as an example. FIG. 15 is a flowchart illustrating how a single user records and searches for a Web Page. The flowchart of FIG. 15 is very similar to that of FIG. 3. All steps in FIG. 15 are the same as those in FIG. 3, but steps 6a, 7a, and 11a are performed by the Web browsing device 31a.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A method of recording and searching for a Web Page, used for a search engine server, wherein a first Web browsing device and a second Web browsing device are connected to the search engine server via a network, such that the search engine server provides a service of Web Page searching for the first Web browsing device and the second Web browsing device, the method comprising the following steps:
receiving recording information, the recording information being transmitted by the first Web browsing device via the network, the recording information comprising a Web address;
indexing Web Page contents corresponding to the Web address to generate information for searching;
building a corresponding relation between the Web address and the information for searching;
receiving search information, the search information being transmitted by the second Web browsing device via the network, the search information comprising at least one key word; and
matching the at least one key word in the information for searching; if the information for searching comprises the at least one key word, then transmitting the Web address corresponding to the information for searching to the second Web browsing device.

2. The method of recording and searching for a web page as claimed in claim 1, wherein the recording information further comprises the Web Page contents, such that the Web Page contents are transmitted by the first Web browsing device via the network.

3. The method of recording and searching for a web page as claimed in claim 2, wherein the recording information further comprises recording whether the recording information is manually uploaded by the first Web browsing device.

4. The method of recording and searching for a web page as claimed in claim 3, wherein the recording information further comprises a first identification code, and building a corresponding relation between the first identification code and the Web address and the information for searching.

5. The method of recording and searching for a web page as claimed in claim 4, wherein the recording information further comprises a label, the label being included in the information for searching.

6. A method of recording and searching for a Web Page, used for a search engine server, wherein a first Web browsing device is connected to the search engine server via a network, such that the search engine server provides a service of Web Page searching for the first Web browsing device, the method comprising the following steps:
receiving recording information, the recording information being transmitted by the first Web browsing device via the network, the recording information comprising a Web address and a first identification code;
indexing Web Page contents corresponding to the Web address to generate information for searching;
building a corresponding relation between the Web address, the first identification code, and the information for searching;
receiving search information, the search information being transmitted by the first Web browsing device via the network, the search information comprising at least one key word; and
matching the at least one key word in the information for searching; if the information for searching comprises the at least one key word, then transmitting the Web address corresponding to the information for searching to the first Web browsing device.

7. The method of recording and searching for a web page as claimed in claim 6, wherein the recording information further comprises the Web Page contents, such that the Web Page contents are transmitted by the first Web browsing device via the network.

8. The method of recording and searching for a web page as claimed in claim 7, wherein the recording information further comprises recording whether the recording information is manually uploaded by the first Web browsing device.

9. The method of recording and searching for a web page as claimed in claim 8, wherein the recording information further comprises a label, the label being included in the information for searching.

10. The method of recording and searching for a web page as claimed in claim 9, wherein the search information comprises the first identification code.

11. A method of recording a browsed Web Page, allowing a user to transmit recording information corresponding to a Web Page to a search engine server via a network when the user uses a browsing program to browse the Web Page, such that the search engine server records the Web Page so that the user will be able to find the Web Page in the future, the method comprising the following steps:
providing an embedded search interface, the embedded search interface being embedded in the browsing program, the embedded search interface comprising a key word input interface and a manual transmission button;
receiving the manual transmission button clicked by the user to transmit the recording information to the search engine server, the recording information comprising a Web address corresponding to the Web Page; and
receiving at least one key word input by the user with the key word input interface.

12. The method of recording a browsed Web Page as claimed in claim 11, wherein the recording information further comprises Web Page contents corresponding to the Web Page.

13. The method of recording a browsed Web Page as claimed in claim 11, wherein the embedded search interface further comprises a setting button, and the setting button comprises a set up blacklist and whitelist button allowing the user to input domain names of corresponding Web Pages he or she does not want to upload.

14. The method of recording a browsed Web Page as claimed in claim 13, wherein the setting button further comprises a button of automatically add, allowing the user to set the automatically add into an on state or an off state, and when the automatically add is in the on state, the recording information corresponding to the Web Page is automatically transmitted to the search engine server; when the automatically add is in the off state, the user has to click the manual transmission button to transmit the recording information to the search engine server.

15. The method of recording a browsed Web Page as claimed in claim 14, wherein the recording information further comprises Web Page contents corresponding to the Web Page.

16. The method of recording a browsed Web Page as claimed in claim 15, wherein the setting button further comprises a button of set up username allowing the user to input an identification code.

17. The method of recording a browsed Web Page as claimed in claim 16, wherein the recording information further comprises the identification code corresponding to the user.

18. The method of recording a browsed Web Page as claimed in claim 17, wherein the embedded search interface further comprises a button of add label allowing the user to input a label corresponding to the Web Page.

19. The method of recording a browsed Web Page as claimed in claim 13, wherein the setting button further comprises a my history button to display the Web address corresponding to the Web Page, wherein the Web address is corresponding to a share button such that the user determines whether or not to share the Web address recorded by him or her via the share button.
